(19) United States
(12) Patent Application Publication
(10) Pub. No.: US 2012/0239419 A1
(43) Pub. Date: Sep. 20, 2012

(54) Medical Information Disk and Cap device

(76) Inventor: Dann M. Allen, Hartford City, IN (US)

(21) Appl. No.: 13/421,263

(22) Filed: Mar. 15, 2012

Related U.S. Application Data
(60) Provisional application No. 61/454,504, filed on Mar. 19, 2011.

(51) Int. Cl. G06Q 50/22

(52) U.S. Cl. 705/2

(57) ABSTRACT

A Medicine bottle closure having a means to indicate real-time data and store and display other important information with the container for the medicine user. This device helps people remember to take medicine and to prevent over-taking medicine when under stress, dementia, or when faced with many prescriptions at essentially the same time. It may be used with existing containers and helps to keep track of when the last pill was taken. It is comprised of a bottle cap or closure means; an electronic storage device; a means to removably connect the device to USB electronic docking device; a docking system to connect to data manipulation center; and software for processing and manipulating the data wherein an individual's medical data.

### CROSS-REFERENCE TO RELATED APPLICATIONS

Not Applicable

This application claims the benefit of Provisional Patent Application Ser. No. 61/454,504 filed Mar. 19, 2011 by Dann Allen and entitled “A medical Information Disk and Cap device and process”.

### FIELD OF INVENTION

This invention relates to a Medicine bottle closure or cap having a means to indicate real time data and store and carry other important medical information with the container for the user of the medicine. This invention is a medical Information Disk and Cap device and a general process of exchanging medical information with the medicine container (specifically the cap) as the means for carrying the data. Particularly this information technology product is related to helping people remember to take medicine or prevent over-taking medicine when under stress, dementia, or when faced with taking several prescriptions at essentially the same time. People need a way to organize and control intake of proscribed medicine without complex means.

The medical Information Disk and Cap device is a combination of modern information technology data input and storage means combined with known devices for dispensing and storing medicine. The applications anticipate use with standard medicine containers of various configurations as discussed below.

### FEDERALLY SPONSORED RESEARCH

None.

### SEQUENCE LISTING OR PROGRAM

None.

### BACKGROUND

### Field of Invention and Prior Art

As far as known, there are no medical Information Disk and Cap devices nor general processes of exchanging medical information with the medicine container (specifically the cap) as the means for carrying the real time data or the like similar to those shown herein. It is believed that this product is unique in its design and technologies.

A. Problem Addressed:

A common problem with dispensing dosages of medicine is forgetting the time at which the last dosage was taken or the time at which the next dosage needs to be taken. It is desirable that the medicine bottle itself incorporate means for indicating the time at which the next dosage is to be dispensed, it is an object of the present invention to provide an improved medicine bottle top which includes a data storage and indication means readily usable by the user for indicating time and storing other valuable data that may be inputted, stored, updated and exchanged by the individual user, the medical doctor, the health facility such as a hospital and the pharmacy from which the medication was dispensed.

B. Prior Art:

The following prior art represents various types of medicine dosage reminder arrangements. First, U.S. Pat. No. 6,152,067 describes a medication dosage reminder device that includes a cruciform hub that attaches to a medication container and an annular dial that is pinned between the hub and the container but is otherwise free to rotate about the hub. The dial includes time of day indicia and the hub includes a co-operating pointer for selecting the time of day so indicated. A patient can rotate the dial about the hub to indicate the time of which the last dose of medication was taken or the time at which the next dose of medication is due. Another U.S. Pat. No. 5,720,392 describes a device for indicating when a person either took a pill or other medication, or when he is scheduled to take the next dose of the medication. The invention is conveniently attached to a pill bottle having a cap. An image of a clock face is printed on or adhered to the top of the bottle cap and/or the bottom and may include either a MEDICATION TAKEN AT image or a MEDICATION DUE AT image. A transparent, rotatable cap, having an arrow indicator inscribed thereon, is placed over the bottle cap. A second transparent, rotatable cup, having an arrow indicator inscribed thereon may be placed over a clock face image and a medication image on the bottom for use as a second timer reminder. When a medication is taken, the rotatable cover covering the MEDICATION TAKEN AT end is turned to the time taken. The opposite end timer is then turned to the MEDICATION DUE AT end to indicate when the next dose is due.

Further, in U.S. Pat. No. 5,694,882 the art describes indicators and methods of indicating. Intended primarily for use with medicine containers, the devices typically indicate the number of doses of medication ingested or remaining to be taken by a patient during a particular period. These devices additionally provide tactile assistance to patients in appropriately repositioning the indicator arms and, when used correctly, may reduce the possibility of patient overdose by restricting improper attempts to advance the indicator arm. Also, in U.S. Pat. No. 5,577,335 there is described a compliance system that helps patients organize and comprehend multiple or single medication and treatment schedules. Containers for prescribed and-over-the-counter drugs are numbered to coordinate with a numbered medication listing and medication profile. The numbered medication listing is made visible on an easel structure that also comprises large master dials whose faces have time or day indicia imprinted and an attached anchor on which a perforated pointer is seated to rotate relative to each other. Optional magnet master dials are provided for other visible places, such as the refrigerator door, to alert to schedule compliance time or day. The numbered containers are provided with small dials, imprinted with time or day indicia, that are perforated to seat on the adhesive anchor arrow indicator to rotate relative to each other. The dials are digitally advanced to the next treatment due time after each procedure is completed to reassure or remind of Schedule compliance and to avoid double dosing a medication. The simplified compliance system can help save time and phone calls in dispensing the required verbal and written drug information by providing a medication profile form and the organized teaching tools to help the patient comprehend the schedule and reinforce the verbal consultations with the system's medication profile.

Again, in U.S. Pat. No. 4,920,912 it describes a time dial for a pharmaceutical container, preferably the container cap. The time dial comprises a disk rotatably mounted on the top surface of the cap; a window in the disk; and a plurality of numerals representing hours arranged in a ring on the top surface of the cap, underlying the disk, whereby rotation of the disk causes a select numeral to appear through the window. Moreover, in U.S. Pat. No. 4,913,083 one describes a method for reminding a person when to take medication. A series of indicia are put on a plurality of flat areas about the circumference of the safety cap, which are in line with the interior stops of the safety cap. The indicia corresponds to times medication is required to be taken. The safety cap is placed upon a safety bottle in such a manner that one of the flat areas line up with an indicator below one of the plurality of exterior stops on the safety bottle that engage with the interior stops of the safety cap so as to show a person the first time medication is to be taken. The safety cap is then removed from the safety bottle and then replaced back on the safety bottle in such a manner that each next in sequence of the flat areas line up with the indicator 22 so as to show the person each next time medication is to be taken.

In still another U.S. Pat. No. 4,345,541 prior art shows and teaches a simple mechanically manipulatable two-component inter-acting device for use as an effective medication-time-intake reminder having an attachable-detachable outer rotatory ring with either a singular or a plurality of outer protrusions for easy clockwise turning purposes in relation to a correspondingly engageable stationary component having a flat circularly running clocklike numeral indicia that are equally interspaced between each succeeding numerals ranging from 1 to 12 is disclosed. Each respective rotary ring has fixed clockwise spacing interval between the “LAST DOSE” arrow indicia and the “NEXT DOSE” arrow indicia depending upon the required application to accomplish the specific time interval in the administration of each corresponding particular medication. For functional effectively it is preferred that each kind of rotatory ring for each respective time-interval application be differentially color-coded to easily distinguish one from the others. Then U.S. Pat. No. 4,041,628 describes an apparatus for visually registering information, which utilizes an outer adjustable member containing transparent indicia, which indicia will become visually distinct when said indicia is moved to overlie an inner fixed member and a color area thereon differing from the color surrounding said indicia.

For another selection, U.S. Pat. No. 4,347,804 describes a simple mechanically manipulatable two-component interacting device for use as an effective medication time intake reminder having a stationary outer ring component having a circularly running clocklike numerical indicia that are equally interspaced between each succeeding numeral ranging from 1 to 12 is disclosed. The inner rotatory disc has fixed interval spacings between the “LAST DOSE” arrow indicia and the “NEXT DOSE” arrow indicia depending upon the required application such as the time interval called for in the administration of each particular medication. It is also disclosed and preferred that each rotatory disc for each respective time interval application be differently color coded to easily distinguish one from the other. U.S. Pat. No. 3,911,856 describes a device for containing medication and for indicating the time when such medication should be taken. The device comprises a base having a plurality of compartments arranged in a circle, and a cover rotatably carried by the base and overlying the compartments. A circular wall defines the outer peripheral portions of the compartments and a circular ledge circumscribes the wall and has an upwardly facing saw-tooth edge. A screw-threaded hub extends upwardly from the center portion of the compartments. The cover is formed of a transparent material, such as clear plastic, and is in the form of a circular disc with a central opening to pass the threaded hub, and an off-center opening, which may be aligned with a selected compartment. The cover has a depending peripheral flange with a saw-tooth edge which is complementary to the edge of the circular ledge. An internally threaded cap is threaded on the hub to hold the cover in place and against unintentional rotation by reason of the fact that the complementary saw-tooth edges are held in mating relationship. All, or selected compartments, are filled with prescribed medicinal tablets and each compartment is marked with a prescribed indicia, such as certain hours of the day. At the prescribed time, the user will rotate the cap in a direction to permit the slight elevation of the cover to disengage the saw-tooth edges, whereby the cover may be rotated to align the cover opening with the desired compartment. The cap is then threaded to move the cover onto the compartments and to engage the saw-tooth edges, and the device may be inverted to remove the tablet from the compartment, through the opening in the cover.

In another, U.S. Pat. No. 3,446,179 the art describes a cover for receptacles having an auxiliary pill-holding portion and a closure member to seal said pill-holding portion, said pill-receiving portion having time indicia inscribed thereon whereby indicating means carried by said closure member will coact with said time indicia to enable the user to record the time the next pill is to be taken, and orientation means provided whereby said closure member can be selectively seated within said pill-receiving portion to preclude accidental movement of said closure member once seated. In U.S. Pat. No. 2,111,637 it describes new and useful improvements in bottle caps, especially of the kind used for medicine bottles, and the said caps have with this object in view been constructed with a recording dial and dose indicator.

Finally, U.S. Pat. No. 1,211,737 describes a device for indicating the particular times at which doses of medicine are to be taken. The object of this invention is to provide an inexpensive indicator, the operation of which is simple and self evident to persons called upon to use it and which is so constructed as to permit the same to be made inexpensively of sanitary material. Notwithstanding the prior art, the present invention is neither taught nor rendered obvious thereby.

### SUMMARY OF THE INVENTION

These new type of medical caps allow the user of the medication to keep track of when their last pill was taken for prescription drugs as well as over the counter medications, vitamins, herbals and etc. One example of how to use/operate is a patient or the user just hits the “reset timer’ on the medication bottle to set the clock back to zero hours and minutes. When instructed to take for example, one pill every 4 hours then the timer can be reset to 00.00 and when timer reaches 04:00. Then reset the timer for the person's next dosage.

Of course many other features could be added to the timer, for example, how many pills were taken, longest time between pills taken, doctor's phone number. Pharmacy' phone number, codes and so on. For daily medications, the cap and data container/timer could be used as a day timer to remind one if he/she have or have not taken their medication that day or multi times that day. These caps with data storage and timers should be able to be produced relatively cheaply just a few cents per cap and be offered as an optional cap.

The preferred embodiment of the medical Information Disk and Cap device is comprised of a bottle cap or closure means; an electronic storage device; a means to removably connect to USB electronic docking device (or equal; a docking system to connect to data manipulation center (computer or equal); and software for processing and manipulating the data wherein an individual's medical data and specific medicine requirements and real time and historical data are inputted, updated and exchanged among the individual, his doctor, his health facility and his pharmacy in a safe, real-time based and private manner to accurately inform the individual and track his medicine intake and proximate (next) requirement.

### OBJECTS AND ADVANTAGES

A common problem with dispensing dosages of medicine is forgetting the time at which the last dosage was taken or the time at which the next dosage needs to be taken. It is desirable that the medicine bottle itself incorporate means for indicating the time at which the next dosage is to be dispensed, it is an object of the present invention to provide an improved medicine bottle top which includes a data storage and indication means readily usable by the user for indicating time and storing real time other valuable historical data that may be inputted, stored, updated and exchanged by the individual user, the medical doctor, the health facility such as a hospital and the pharmacy from which the medication was dispensed. The medical Information Disk and Cap device may be far more than a timer and may store various types of data as discussed in the details below.

This device and information sharing system means that less mistakes may be made. That is because the actual written prescriptions from a physician may be compared to the information given in the Medical Cap. The type and strength of the medication and dosages are clear even if there were sloppy handwriting from some doctors and other health care personnel.

Specific to implementation and operation of other prior art, this medical Information Disk and Cap device permits the use of the existing bottle or container. The additional features of the medical Information Disk and Cap device are compact and are built directly into the cap. Therefore, the device relates to a Medicine bottle closure or cap and not the whole container.

As a related advantage, since the cap or closure is the major component changed, the need to use another device or bottle is eliminated. This means, unlike prior art, there is not a need to transfer medicine from the bottle dispensed by the pharmacy to a new device with the timing and tracking features. The same basic bottle or container is used in combination with a new cap having the timing and tracking storage media and information sharing technology “built-in” to a basic cap. Likewise, the current anti-tampering and child-proof bottles with locking closures may have a compact, low profile electronics package inserted directly into the cap recess as shown below.

The overall information sharing system can be implemented easily with minor or no changes to ones current and basic computing devices. For example and not as a limitation, the desk top, hand held, laptop, net book, tablet, smart phones and plethora of existing and newly emerging computers hardware may all be interface tools with the medical Information Disk and Cap device. New and costly upgrades to equipment and software are avoided.

Finally, other advantages and additional features of the present medical Information Disk and Cap device will be more apparent from the accompanying drawings and from the full description of the device. For one skilled in the art and the field of electronics and time tracking and associated information technology techniques, devices and uses of the technology, it is readily understood that the features shown in the examples with this product are readily adapted to other types of data storage and exchange for simple medical devices like a cap on a medicine bottle.

### DESCRIPTION OF THE DRAWINGS

### Figures

The accompanying drawings, which are incorporated in and constitute a part of this specification, illustrate an embodiment of the medical Information Disk and Cap device that is preferred. The drawings together with the summary description given above and a detailed description given below serve to explain the principles of the medical Information Disk and Cap device. It is understood, however, that the medical Information Disk and Cap device is not limited to only the precise arrangements and instrumentalities shown.

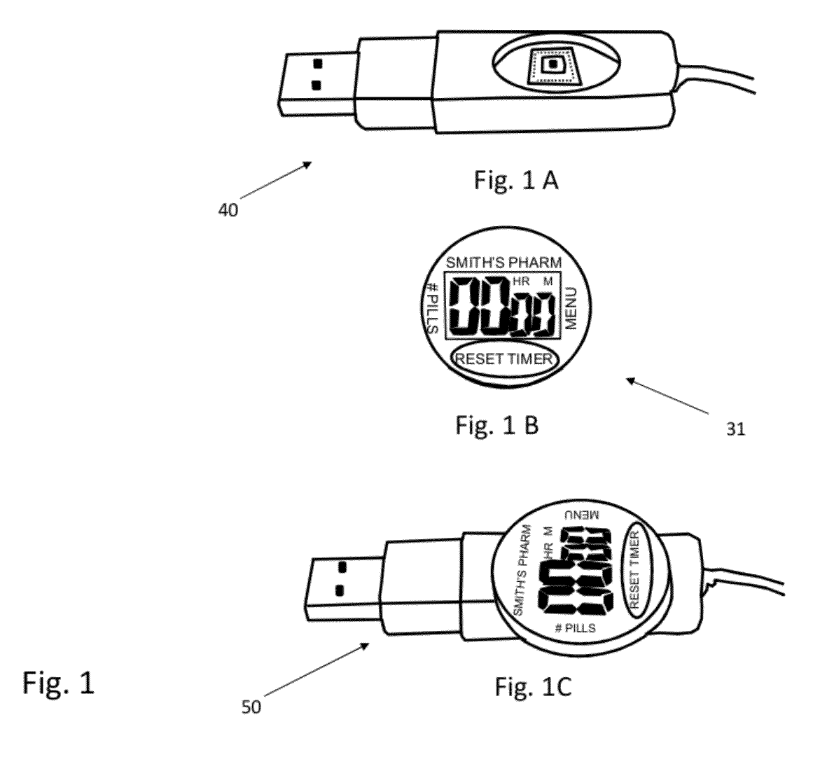

FIGS. 1 A through 1 C are sketches of the medical Information Disk and Cap devices for safely handling prescriptions.

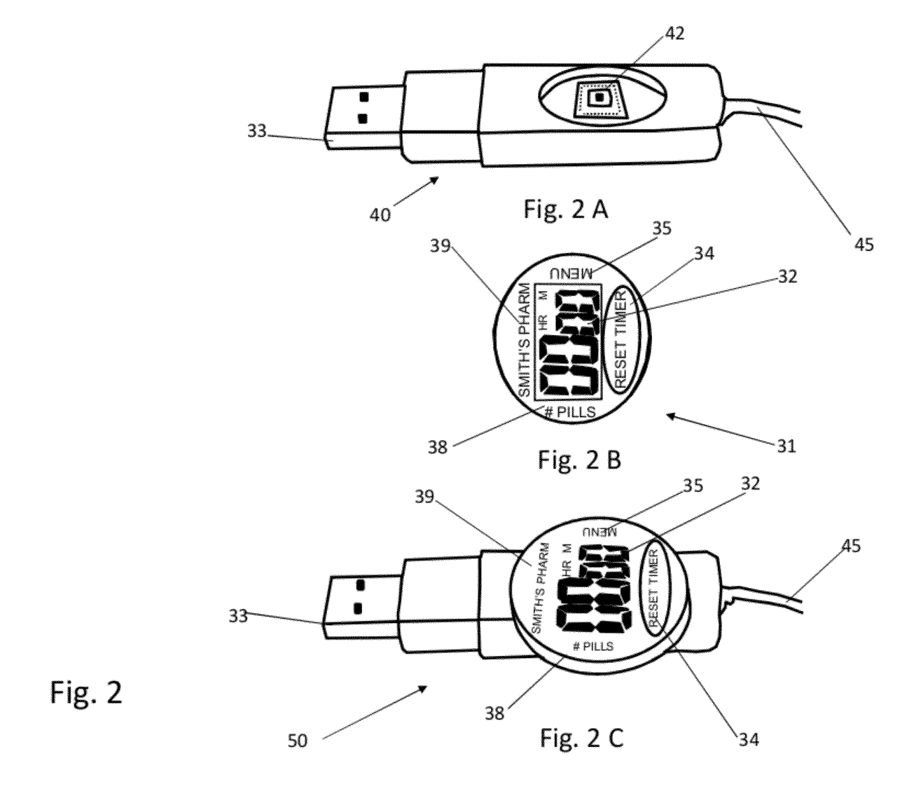

FIGS. 2 A through 2 C are sketches of the medical information Disk and Cap devices for safely handling prescriptions with the sketches noting the general components and features.

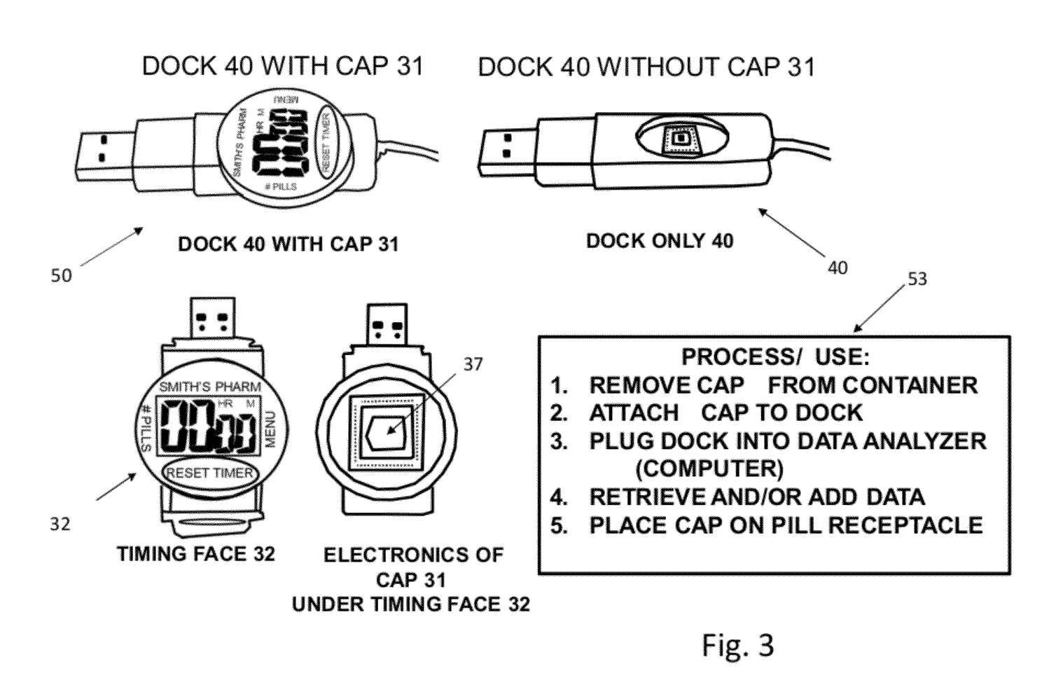

FIG. 3 are sketches of a prototype sample of the medical Information Disk and Cap devices shown from generally a top view.

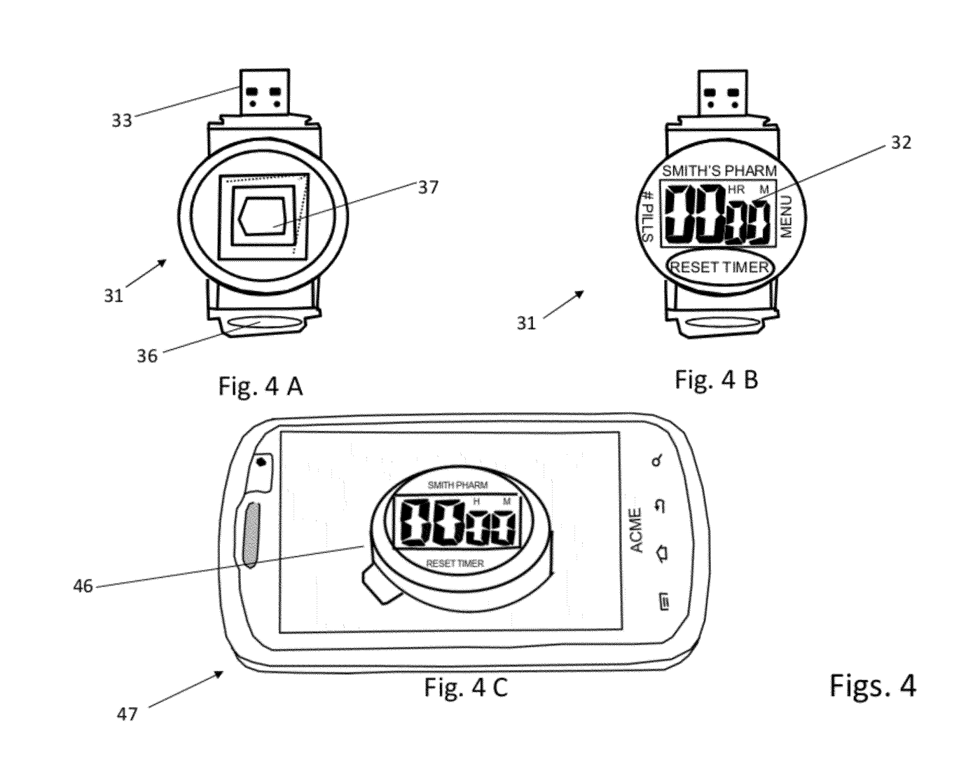

FIGS. 4 A through 4 C are sketches of a prototype sample of the medical Information Disk and Cap device with the timing face and the electronics shown and of an application for a cellphone.

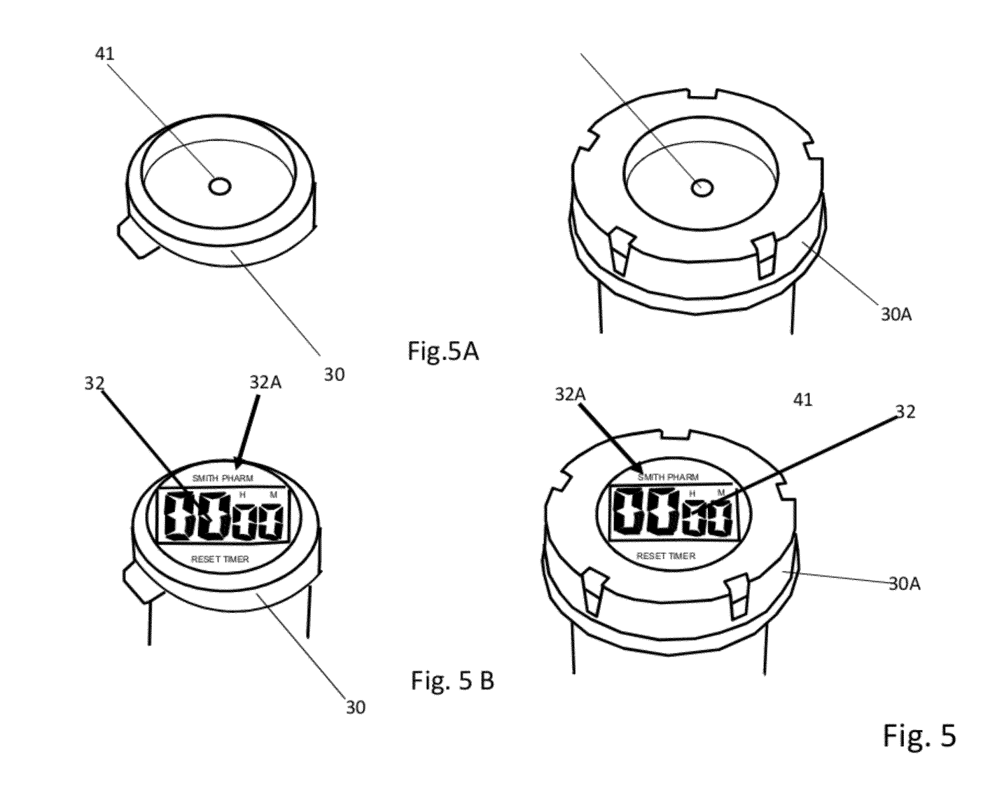

FIGS. 5 A and 5 B are sketches of prototype samples for different bottle caps.

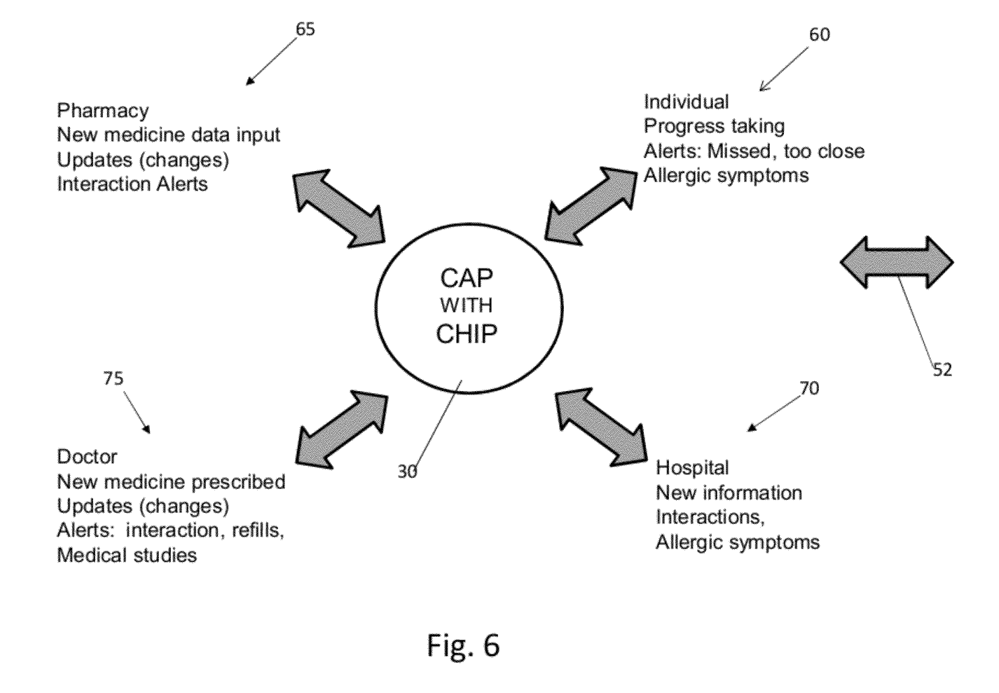

FIG. 6 is a sketch of the process of data exchange for using the medical Information Disk and Cap devices.

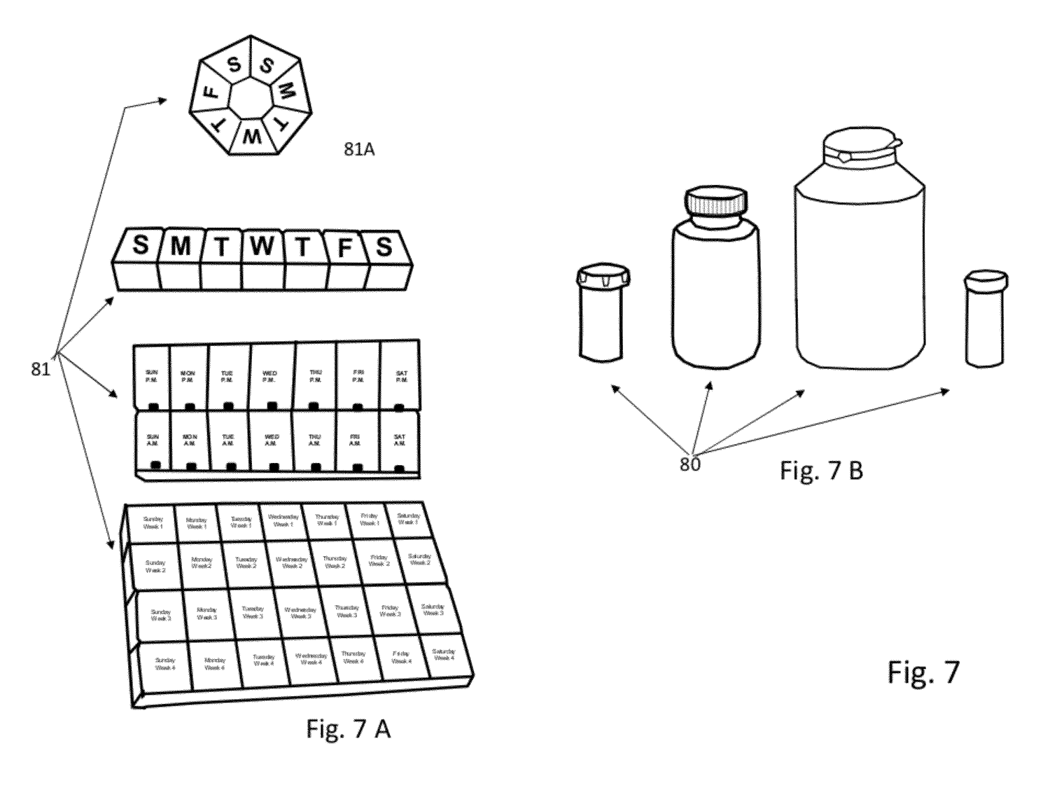

FIGS. 7 A and 7 B are examples and not limitations of the different pill containers that may be used with the medical Information Disk and Cap device.

### DESCRIPTION OF THE DRAWINGS

### Reference Numerals

The following list refers to the drawings:

TABLE A
Reference numbers

| Ref | |
|---|---|
| # | Description |
| 30 | Cap with chip device medical Information Disk and Cap device |
| 30A | Alternative cap with chip |
| 31 | General medical information cap |
| 32 | Timing face |
| 32A | Information electronics part |
| 33 | Direct USB connection |
| 34 | Reset button |
| 35 | Menu button |
| 36 | Carry/security loop |
| 37 | Electronics under timing face 32 |
| 37A | Data storage in the cap |
| 38 | No. pills to take |
| 39 | Contact advertisement - pharmacy/doctor/hospital |
| 40 | USB docking station to interconnect medical cap to computer |
| | or information exchange dock |
| 41 | Cap recess (for insert of electronics and timing face |
| 42 | Transfer connection cap to port |
| 45 | Direct/hard wired option |
| 46 | Computer Application (app) for an android - Droid ™ or |
| | IPod ™ application |
| 47 | Cell telephone such as a Droid ™ or IPod ™ |
| 50 | Medical cap and disk 31 on docking station 40 |
| 51 | SIMPLE USE INSTRUCTIONS |
| 52 | Data exchange - upload/down load |
| 53 | The general process of exchanging medical information with |
| | the medicine container (cap) as the means for carrying the |
| | data |
| 60 | Individual medicine taker or caretaker |
| 65 | Pharmacy |
| 70 | Hospital/Med Center/paramedics and Emergency Medical |
| | Technicians—EMTs |
| 75 | Doctor/Physician/medical provider and/or |
| 80 | Various types of pill container vessels (bottles or the like) |
| 81 | Daily/weekly/monthly pill caddies |
| 81A | Weekly disk pill caddies |

### DETAILED DESCRIPTION OF PREFERRED EMBODIMENT

The present development is a medical Information Disk and Cap device and a general process of exchanging medical information with the medicine container (specifically the cap) as the means for carrying the data. Particularly this information technology product is related to helping people remember to take medicine or prevent over-taking medicine when under stress, dementia, or when faced with taking several prescriptions at essentially the same time. People need a way to organize and control intake of proscribed medicine without complex means.

Being taught here are the ways a cap on a medicine bottle may be used to store, exchange and use medical data in a way to enhance messages to the individual as to taking the medicine and facilitate data exchange to and from the individual with the medical doctor, the medical facility and the pharmacy. All this data is handled by combining the most current and sophisticated information technology with a simple medicine bottle cap. This may be used as an add-on to current prescriptions already in use or with new prescriptions as the medicine is added or a dosage changed.

The problems and advantages for the medical Information Disk and Cap device 30 are listed above in the introduction.

The preferred embodiment of the medical Information Disk and Cap device is comprised of a bottle cap 30A or closure means with a time face 32; an electronic storage device 37A and means 37 to removably connect to a USB electronic docking device (or equal); a docking system 40 with a means 42 to connect to the cap 30A and a means 33 to connect to data manipulation center (computer or equal—center not shown and furnished by others); and software (not shown) for processing and manipulating the data wherein an individual's medical data and specific medicine requirements and data are inputted, updated and exchanged among the individual, his doctor, his health facility and his pharmacy in a safe, real-time based and private manner to accurately inform the individual and track his medicine intake and proximate (next) requirement. An alternative embodiment would anticipate and use a means blue tooth system to transmit and receive or a wireless remote transmitter and receiver system to replace the hard docking by wire (USB or equal).

There is shown in FIGS. 1-7 a description and operative embodiment of the medical Information Disk and Cap device. In the drawings and illustrations, one notes well that the FIGS. 1-5 demonstrate the general configuration, FIG. 6 the use of this product; and FIG. 7 show examples but not limitations of medicine containers that may use the new device. The various example uses are in the operation and use section, below.

The accompanying drawings, which are incorporated in and constitute a part of this specification, illustrate an embodiment of the medical Information Disk and Cap device 30 that is preferred. The drawings together with the summary description given above and a detailed description given below serve to explain the principles of the medical Information Disk and Cap device 30. It is understood, however, that the cap device 30 is not limited to only the precise arrangements and instrumentalities shown. Other examples of cap and data storage means and devices are still understood by one skilled in the art and in the field of electronics and time tracking and associated information technology techniques, devices and uses of the technology. The scope and spirit of the medicine data cap is well appreciated by the one skilled as how it may be incorporated in other similar devices and be within the scope and spirit shown here.

FIGS. 1 A through 1 C are sketches of the medical Information Disk and Cap 31 devices for safely handling prescriptions. The FIG. 1 A is the docking system 40; FIG. 1 B is the bottle cap device 31; and FIG. 1 C is the combination 50 of the docking system 40 with the information medical cap 31.

FIGS. 2 A through 2 C are sketches of the medical Information Disk and Cap devices 31, 40, and 50 for safely handling prescriptions with the sketches noting the general components and features. Shown in FIG. 2 A is the docking system 40 has a means to connect 42 to permit the timing cap 31 to removably interconnect to the docking system 40. There is also a provision to direct connect or hard wire 45 and a USB plug 33 or equal to connect to the computer or data processor (not shown and provided by others). Shown in FIG. 2 B is general medical information cap 31 with several buttons—the menu select button 35, the start/stop/reset button 34 and the number of pills taken button 38. Likewise in this view is the contact information logo or button 39, the time face 32 (where all the information is displayed alpha-numerically on a back lit data screen), a security loop 36, and an optional direct connect USB (for some options) that permit the time piece (on some options) to mate direct to a computer. In FIG. 2 C is shown the combination 50 with the cap 31 direct mounted on the docking station 40. The other features are noted and described above. These different connection designs may be one of a plethora of designs for computer connections and docking. The one example here is a USB type connection. A person having ordinary skill in the field of electronics and time tracking and associated information technology techniques, devices and uses of the technology well appreciates the many types of connections available . . . both wired and wireless . . . that accomplishes the scope and spirit of the medical Information Disk and Cap device by the different connections. Likewise the data input, exchange and software options would fill volumes of “how-to” manuals. The importance here is the new combination of data storage, exchange and updating to real time to enhance the information one has relative to taking his required medicine and immediate feedback to him and others (doctor, health facility, pharmacy, etc.) that need or have updates to the information.

FIG. 3 are sketches of a prototype sample of the medical Information Disk and Cap devices 31 shown from generally a top view. As labeled, the dock 40 only is shown; the dock 40 and cap 31; the timing face 32 only; and the time piece removed with the electronics 37 under the face 32 and connection 37A (hidden), Also shown is the general process 53 in this TABLE B.

Process/Use 53:
STEP 1. REMOVE CAP 31 FROM PILL CONTAINER 80, 81
STEP 2. ATTACH CAP 31 TO DOCK 40
STEP 3. PLUG DOCK INTO DATA ANALYZER (COMPUTER NOT SHOWN)
STEP 4. RETRIEVE AND/OR ADD DATA
STEP 5. PLACE CAP ON PILL RECEPTACLE
STEP 6. REPEAT AD NEEDED
wherein a group of medical data of an individual and specific medicine requirements and data are inputted, updated and exchanged among the individual, his doctor, his health facility and his pharmacy in a safe, real-time based and private manner to accurately inform the individual and track his medicine intake and proximate (next) requirement

FIGS. 4 A and 4 B are sketches of a prototype sample 31 of the medical Information Disk and Cap device 30 with the timing face 32 and the electronics 37 shown (32 and 37 collectively the insert 32A). A connection 33 may be a direct connect for a medicine cap 31 may also be used for set up and calibration of the caps at some locations. FIG. 4 C is a sketch of the medical cap device 30 that interfaces with a cell phone or personal data device as an application. Here the application (app.) for an android—Droid™ or Ipod™ application 46 is shown with a droid or android telephone 47 device. It would be similar tone utilized with an I-Pod™ or other phone or computer device. The device may be directly connected as by the USB or by means of a remote such as a Bluetooth™ connection or the like.

FIGS. 5 A and 5 B are sketches of prototype samples 30, 30A for different medical information bottle caps 31 such as an easy off cap 30 or a more child proof 30A. FIG. 5 A shows a sample of what the caps 30, 30A could look like without the information electronics 32A part of the combination. The molded cap has a recess 41 provided in which to place the electronics 32A. Caps 30, 30A will come in all different sizes and styles as shown further in FIG. 7B. These examples in FIG. 5 A are showing just one way the caps could be altered with a recess feature 41 for the new information electronics 32A part of the combination could be applied. In FIGS. 5 B the insert electronics 32A has been placed into the recess 41. Each type 31 still has the electronics 37, 37A and timing face readout 32 built into the cap.

FIG. 6 is a sketch of the process of data exchange for using the medical Information Disk and Cap devices. FIGS. 7 A and 7 B are examples and not limitations of the different pill containers that may be used with the medical Information Disk and Cap device. These figures are discussed below in the operation of the device and the general process.

The details mentioned here are exemplary and not limiting. Other specific components and manners specific to describing a medical Information Disk and Cap device 30 may be added as a person having ordinary skill in the field of electronics and time tracking and associated information technology techniques, devices and uses of the technology well appreciates. Likewise the general process 53 of exchanging medical information with the medicine container (cap) as the means for carrying the data that is associated is well within the general scope and spirit of the invention shown here within.

### Operation of the Preferred Embodiment

The medical Information Disk and Cap devices 30 has been described in the above embodiment. The manner of how the device operates is described below. One notes well that the description above and the operation described here must be taken together to fully illustrate the concept of the medical Information Disk and Cap device 30 and associated processes 53. The preferred embodiment of the medical Information Disk and Cap device is comprised of a bottle cap 30A or closure means with a time face 32; an electronic storage device 37A and means 37 to removably connect to a USB electronic docking device (or equal); a docking system 40 with a means 42 to connect to the cap 30A and a means 33 to connect to data manipulation center (computer or equal—center not shown and furnished by others); and software (not shown) for processing and manipulating the data wherein an individual's medical data and specific medicine requirements and data are inputted, updated and exchanged among the individual, his doctor, his health facility and his pharmacy in a safe, real-time based and private manner to accurately inform the individual and track his medicine intake and proximate (next) requirement.

FIG. 6 is a sketch of the process of data exchange for using the medical Information Disk and Cap devices. Here the data is exchanged by a two-way process 52. The overall information sharing system can be implemented easily with minor or no changes to a user's current and basic computing devices. For example and not as a limitation, the desk top tower computer, hand held devices, laptop computers, net book computers, personal computer tablets, smart phones and a plethora of other existing and newly emerging computers hardware may all be interface tools with the medical Information Disk and Cap device. New and costly upgrades to equipment and software are avoided. The exchange may be wired or wireless but for economy, most will be wired through a docking station 40 for now until the wireless systems become economically efficient to merit the addition to the exchange system. Here the exchanges are shown for four (4) main users and providers of medical information that is important for the individual:

1. Individual 60
Progress taking the medication
Alerts: Missed, too close
Allergic symptoms

2. Pharmacy 65
New medicine data input
Updates (changes)
Interaction Alerts

3. Hospital, Paramedics and EMTs 70
New information
Interactions,
Allergic symptoms

4. Doctor 75
New medicine prescribed
Updates (changes)
Alerts: interaction, refills, Medical studies

5. Pharmaceutical Company
History of taking the medicine
Mistakes outside of the drug composition
Records for litigious actions

FIGS. 7 A and 7 B are examples and not limitations of the different pill containers 80, 81 that may be used with the medical Information Disk and Cap device 31. The medical Information Disk and Cap device 31 may be easily adapted for use with the daily, weekly, monthly pill strips 81 or disks 81A. Likewise, the medical Information Disk and Cap device 31 anticipates use on various types of pill containers as exemplified by the group 80. One person having ordinary skill in the field of electronics and time tracking and associated information technology techniques, devices and uses of the technology well appreciates that its type of electronics may be easily adapted for other configurations. Therefor the containers 81, 81A and 80 are offered as examples and not as limitations to the scope and spirit of this new combination of electronics and container caps for tracking medical requirements for a specific individual. Specific to implementation and operation of other prior art, this medical Information Disk and Cap device permits the use of the existing bottle or container. The features of the medical Information Disk and Cap device are of being compact and being able to be built directly into the cap. Therefore, the device relates to a Medicine bottle closure or cap and not the whole container. The cap is utilized in combination with bottles and containers like those shown in FIGS. 7 A and 7 B.

Many uses are anticipated for the medical Information Disk and Cap device 31. Some examples, and not limitations, are shown in the following Tables by the ones that will input the example data to the medical data storage cap 31.

TABLE C
Some examples of Information and data for the doctor prescribing
the medication about properly taking the medication.

| Item | Description |
|---|---|
| 1 | When the next pill could be taken prescribed by the |
| | physician with alarm or not |
| 2 | How many pills have been taken |
| 3 | What was the longest times between when the pills |
| | were taken |
| 4 | Were all pills taken |
| 5 | The average time between pills |
| 6 | How many more refills on their prescription |

TABLE D
Some examples of Information and data about
the individual taking the medication.

| Item | Description |
|---|---|
| 1 | time and date of the next doctor's appointment |
| 2 | next of kin and all their contact numbers |
| 3 | phone numbers of the pharmacy |
| 4 | Doctor that prescribed the medicine |
| 5 | Name of Doctor |
| 6 | The physician regular, after hour, emergency phone |
| | numbers and any other info about their physician |
| 7 | Family history of any unique medical problems. |
| 8 | Blood type |
| 9 | Past illnesses |
| 10 | User's name |
| 11 | User's age |
| 12 | Past injuries |
| 13 | Medicines to which the user has allergic reactions |

TABLE E
Some Examples of Specific drug information about the medication

| Item | Description |
|---|---|
| 1 | Maker of this drug |
| 2 | name of drug and generics |
| 3 | dosage amounts |
| 4 | What to do if over dose occurs |
| 5 | Best way for dosage to be take medication |
| 6 | Side effects of medication |
| 7 | What other prescription medications this patient is taken |
| 8 | interactions with this med |
| 9 | EMS could find out |
| 10 | allergic reactions |

With this description it is to be understood that the medical Information Disk and Cap device 30 is not to be limited to only the disclosed embodiment of product. The features of the medical Information Disk and Cap device 30 are intended to cover various modifications and equivalent arrangements included within the spirit and scope of the description. Likewise the general process 53 of exchanging medical information with the medicine container (cap) as the means for carrying the data is included within the scope and spirit.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

With this description it is to be understood that the medical Information Disk and Cap device and the process of exchanging medical information by using the cap for the data are not to be limited to only the disclosed embodiment of device and process. The features of the device are intended to cover various modifications and equivalent arrangements included within the spirit and scope of the description.

What is claimed is:

1. The preferred embodiment of the medical Information of an individual on a Disk and Cap device is comprised of
(a) a bottle cap and closure means (30A) with a time face (32);
(b) an electronic storage device (37A);
(c) means (37) to removably connect to a USB electronic docking device;
(d) a docking system (40) with a means (42) to connect to the cap (30A) and a means (33) to connect to data manipulation center (computer or equal—center not shown and furnished by others); and
(e) a software program for processing and manipulating the data
wherein a group of medical data of an individual and specific medicine requirements and data are inputted, updated and exchanged among the individual, his doctor, his health facility and his pharmacy in a safe, real-time based and private manner to accurately inform the individual and track his medicine intake and proximate (next) requirement.

2. The device according to claim 1 wherein a user is from the group consisting of an individual (60), a pharmacy (65), a hospital (70), and medical professional (75).

3. The preferred embodiment of the medical Information Disk and Cap device is comprised of
(a) a bottle cap and closure means (30A) with a time face (32);
(b) an electronic storage device (37A);
(c) means blue tooth system to transmit and receive, wireless remote transmitter and receiver (37) to remotely connect to a computer; and
(d) a software program for processing and manipulating the data
wherein a group of medical data of an individual and specific medicine requirements and data are inputted, updated and exchanged among the individual, his doctor, his health facility and his pharmacy in a safe, real-time based and private manner to accurately inform the individual and track his medicine intake and proximate (next) requirement.

4. The device according to claim 3 wherein the means to remotely connect is a Bluetooth system for transmitting and receiving signals.

5. The device according to claim 3 wherein the means to remotely connect is a wireless system for transmitting and receiving signals.

6. The device according to claim 3 wherein the computer is an hand-held telephone with a user application.

7. The device according to claim 3 wherein a user is from the group consisting of an individual (60), a pharmacy (65), a hospital, a paramedic, an EMT (70), a pharmaceutical company, and medical professional (75).

8. The process for storing and updating medical Information of an individual on a Disk and Cap is comprised of:
STEP 1. REMOVE CAP (31) FROM PILL CONTAINER (80),(81);
STEP 2. ATTACH CAP (31) TO DOCK 40;
STEP 3. PLUG DOCK (40) INTO DATA ANALYZER OF A COMPUTER;
STEP 4. RETRIEVE AND/OR ADD DATA;
STEP 5. PLACE CAP ON PILL RECEPTACLE; and
STEP 6. REPEAT AD NEEDED
wherein a group of medical data of an individual and specific medicine requirements and data are inputted, updated and exchanged among the individual, his doctor, his health facility and his pharmacy in a safe, real-time based and private manner to accurately inform the individual and track his medicine intake and proximate (next) requirement.
